(19) United States
(12) Patent Application Publication
(10) Pub. No.: US 2008/0200592 A1
(43) Pub. Date: Aug. 21, 2008

(54) Plasticizer composition containing cyclodextrin derivatives, flexible PVC composition with suppression of the migration of plasticizer containing the same, and manufacturing method thereof

(75) Inventors: Seung-Yeop Kwak, Seoul (KR); Byong-Yong Yu, Kyunggi-Do (KR); Jae-Woo Chung, Seoul (KR)

Correspondence Address: Edwards Angell Palmer & Dodge LLP, P.O. Box 55874, Boston, MA, 02205, US

(73) Assignee: Seoul National University Industry Foundation, Seoul (KR)

(21) Appl. No.: 12/011,837

(22) Filed: Jan. 29, 2008

(30) Foreign Application Priority Data
Jan. 31, 2007 (KR) 10-2007-0010023

(51) Int. Cl. C08L 5/16

(52) U.S. Cl. 524/48

(57) ABSTRACT

The present invention relates to a plasticizer composition containing cyclodextrin derivatives, a flexible PVC composition with suppression of the migration of plasticizer containing this plasticizer composition, and a manufacturing method of the PVC composition. The manufacturing method includes the steps of: (S1) preparing a cyclodextrin derivative, in which hydrogens of a cyclodextrin are substituted with a certain compound; (S2) mixing the cyclodextrin derivative, PVC and a low molecular weight liquid plasticizer to form a plastisol; and (S3) heating the plastisol into liquid and cooling the plastisol. This manufacturing method uses cyclodextrin derivatives, in which cyclodextrins are modified with certain compounds, and these derivatives form a complex with the low molecular weight liquid plasticizer to suppress plasticizer migration. Thus, this method thereby allows mass-production of the flexible PVC with suppressed plasticizer migration in a simple and economical manner without using a solvent.

### BACKGROUND OF THE INVENTION

1. Field of the Invention

The present invention relates to a method for manufacturing a flexible PVC, which mixes PVC and a low molecular weight liquid plasticizer to manufacture the flexible PVC, and in particular, to a plasticizer composition which is mixed with a low molecular weight liquid plasticizer to form a complex, thereby suppressing plasticizer migration when used as a plasticizer, a manufacturing method of a flexible PVC composition with suppression of the migration of plasticizer containing the same, and the flexible PVC composition with suppression of the migration of plasticizer, manufactured thereby.

2. Description of the Related Art

Poly(vinyl chloride) (PVC) is a typical all-purpose resin that has wide applications, for example pipes, materials for packaging foods, fiber for textiles, interior decorations, blood storage containers or products for infants such as nursing bottles or toys. However, PVC has a limitation in molecular mobility due to its unique hierarchy structure and microcrystallite serving as physical crosslinks, and thus exhibits hard characteristics, and by this reason, PVC should be provided with flexibility through a plasticization process for use of flexible characteristics, for example a film for packaging foods. Generally, a flexible PVC is manufactured such that PVC resin is mixed with a low molecular weight liquid plasticizer to form a plastisol, which is heated so that the PVC is dissolved in the low molecular weight liquid plasticizer and then cooled. Known low molecular weight liquid plasticizers include phthalate plasticizers, phosphate plasticizers, trimellitate plasticizers and aliphatic diester plasticizers, and may further include epoxy plasticizers and anti-chlorine plasticizer. The low molecular weight liquid plasticizer considerably improves the molecular mobility of PVC, to provide the PVC with flexibility.

As described above, the low molecular weight liquid plasticizer may be useful in providing the PVC with flexibility, but has inherent physical properties of a low molecular weight liquid material, for example volatilization into the air or outward transfer through contact with liquid or solid materials. It has been reported that, when a plasticizer migrating from PVC enters the bodies of animals or plants, the plasticizer may disrupt a normal activity of the endocrine system directly involved with vital activities or cause an abnormal reaction of the endocrine system, thereby resulting in a fatal harm to the bodies of animals or plants.

Therefore, efforts have been made to reduce the amount of outward migration of plasticizers.

For example, to solve the problem of plasticizer migration in flexible PVC products, there have been attempts to replace low molecular weight liquid plasticizers with high molecular weight plasticizers. However, high molecular weight plasticizers have the disadvantages of reduced economical efficiency, insufficient plasticization and generation of chain entanglement.

Meanwhile, according to the Journal of Applied Polymer Science, 1996, Vol. 59, P. 2089 “Effect of blending β-cyclodextrin with poly(vinyl chloride) on the leaching of phthalate ester to hydrophilic medium”, it is reported that cyclodextrin forms a complex with a low molecular weight liquid plasticizer such as DOP, and thus contributes to suppress migration of plasticizer from a flexible PVC.

In the same manner as alpha-cyclodextrin of the following Chemistry Figure 1, a cyclodextrin is a cyclic compound composed of repeating glucose units and can be represented by the following Chemistry Figure 2.

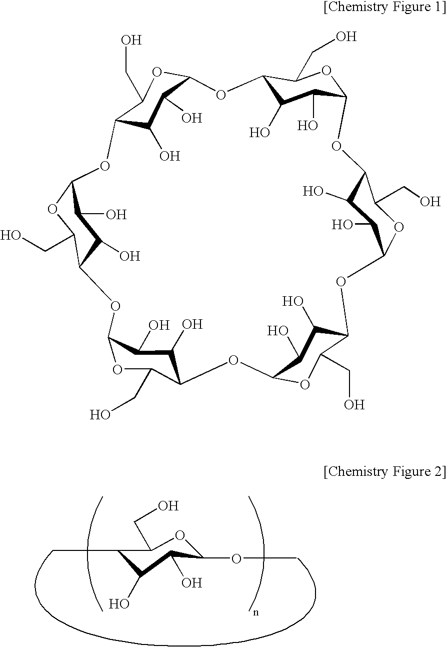

wherein n, the number of repeating glucose units is an integer of 6 to 26, preferably 6 to 8.

The cyclodextrin has a hydrophilic outer part surrounded by hydroxyl functional groups, and a hydrophobic inner cavity. The cyclodextrin may form a complex with a plasticizer having such a size as to enter the inner cavity, i.e. a low molecular weight liquid plasticizer. And, the low molecular weight liquid plasticizer may be drawn and fixed into the inner cavity by hydrophobic interaction or through hydrogen bonds.

However, the cyclodextrin mixed with PVC and the low molecular weight liquid plasticizer has a poor dispersibility, and thus forms aggregates, thereby considerably reducing its capability of suppressing plasticizer migration and deteriorating physical properties of the resultant flexible PVC. To solve these problems, the above-mentioned papers suggested to disperse PVC, DOP and cyclodextrin in a dimethylacetamide (DMAc) solvent and cast the resultant mixture to manufacture a flexible PVC with suppressed plasticizer migration. However, this suggestion has the disadvantages of low economical efficiency, unrealizable mass-production of PVC products and incomplete solution of the cyclodextrin cohesion problem.

The present invention is designed to solve the problems of the prior art, and therefore it is an object of the present invention to provide a manufacturing method of a flexible PVC composition with suppression of plasticizer migration. The inventive method allows mass-production of flexible PVC compositions capable of suppressing plasticizer migration in a simple and efficient manner with no need of a solvent while supporting a dramatic reduction in plasticizer leaks and less deterioration of physical properties in the resultant flexible PVC.

It is another object of the present invention to provide a plasticizer composition which is mixed with a low molecular weight liquid plasticizer to form a complex, thereby suppressing plasticizer migration when used as a plasticizer without deteriorating the physical properties of the resultant flexible PVC. It is still another objective of the present invention to provide a flexible PVC composition with suppression of plasticizer migration containing said plasticizer composition.

### SUMMARY OF THE INVENTION

In order to achieve the above-mentioned objects, a manufacturing method of a flexible PVC composition with suppressed plasticizer migration, includes (S1) preparing a cyclodextrin derivative represented by the following Chemistry Figure 3; (S2) mixing the cyclodextrin derivative, PVC and a low molecular weight liquid plasticizer to form a plastisol; and (S3) heating the plastisol into liquid and cooling the plastisol:

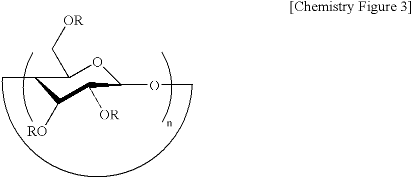

wherein each R, having 1 to 20 carbon atoms, is a functional group independent of one another, represented by the following Chemistry Figure 4 and has a degree of substitution of 5 to 100%, and n is an integer of 6 to 26, and

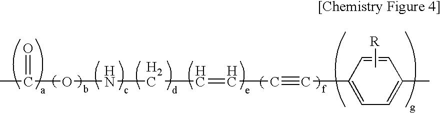

wherein a, b, c, d, e and f each is an integer of at least 0 and g is an integer of at least 1 with a+b+c+d+e+f+g being at least 1, and wherein the linking order among said constituent units of a, b, c, d, e, f and g can vary at random, and R is benzene, benzene derivatives, naphthalene, or naphthalene derivatives. R may be arranged regardless of the positions of ortho, meta and para.

The manufacturing method according to the present invention supports the mass-production of flexible PVC with suppressed plasticizer migration in a simple and economical manner with no need of a solvent. The inventive method is capable of considerably reducing the amount of migrating plasticizers without deteriorating the physical properties of the resultant flexible PVC.

According to the manufacturing method of a flexible PVC composition with suppression of plasticizer migration of the present invention, preferably the cyclodextrin derivatives have the content of 2 to 20 mol based on 100 mol content of the low molecular weight liquid plasticizer.

According to the manufacturing method of a flexible PVC composition with suppression of plasticizer migration of the present invention, the low molecular weight liquid plasticizer may include any one or mixtures of at least one selected from the group consisting of a phthalate plasticizer such as dimethyl phthalate (DMP), dibutyl phthalate (DBP), di-isobutyl phthalate (DIBP), dihexyl phthalate (DHP), dioctyl phthalate (DOP), diisooctyl phthalate (DIOP), dinonyl phthalate (DNP), di-isodecyl phthalate (DIDP) and benzyl butyl phthalate (BBP), an aliphatic diester plasticizer such as dioctyl adipate (DOA), diisooctyl adipate (DIOA) and diisodecyl adipate (DIDA), a trimellitate plasticizer such as triisooctyl trimellitate (TIOTM), and a phosphate plasticizer such as tri-tolyl phosphate (TTP) and trixylyl phosphate (TXP).

### BRIEF DESCRIPTION OF THE DRAWINGS

FIG. 1 is a view schematically illustrating the structure of alpha-cyclodextrin derivatives as an embodiment of cyclodextrin derivatives used in the present invention.

FIG. 2 is a view schematically illustrating the structure of cyclodextrin derivatives which form a complex by drawing DOP into an inner cavity in the plasticizer composition of the present invention.

FIG. 3 is a view schematically illustrating the structure of a flexible PVC composition with suppressed plasticizer migration, in which PVC, a low molecular weight liquid plasticizer and a cyclodextrin derivative are uniformly mixed according to the present invention.

FIG. 4 is a surface photograph of a sample (PVC-0) of comparison example 1 containing no cyclodextrin derivatives.

FIG. 5 is a surface photograph of a sample (PVC-3) of comparison example 3 containing a predetermined amount of cyclodextrin derivatives.

FIG. 6 is a surface photograph of a sample manufactured by dispersing a pure beta-cyclodextrin in DMAc solution according to the prior art.

FIG. 7 is a calibration curve of absorbance of standard solutions manufactured for evaluation of migration concentration of a phthalate plasticizer.

FIG. 8 is a graph illustrating DOP migration test results of flexible PVC samples with suppression of plasticizer migration according to the present invention.

FIG. 9 is a stress-strain curve graph of flexible PVC samples with suppression of plasticizer migration according to the present invention.

### DESCRIPTION OF THE PREFERRED EMBODIMENT

Hereinafter, a manufacturing method of a flexible PVC composition with suppression of plasticizer migration will be described in detail.

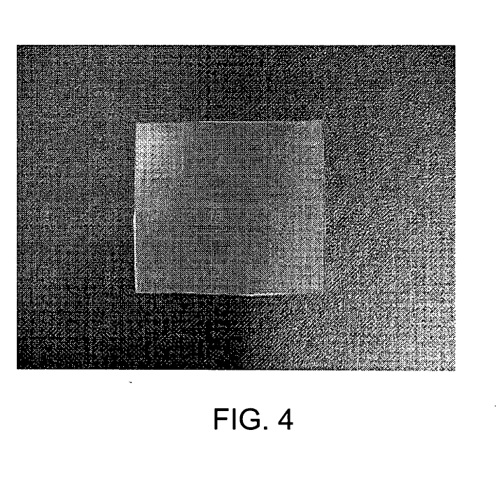

First, cyclodextrin derivatives represented by the following Chemistry Figure 3 are prepared (S1).

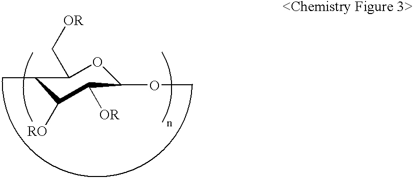

wherein R is a functional group, which replaces the hydrogen of a hydroxyl functional group. Each R is independently a functional group having 1 to 20 carbon atoms, represented by the following Chemistry Figure 4, and R has a degree of substitution of 5 to 100%, and n is an integer of 6 to 26 (preferably 6 to 8).

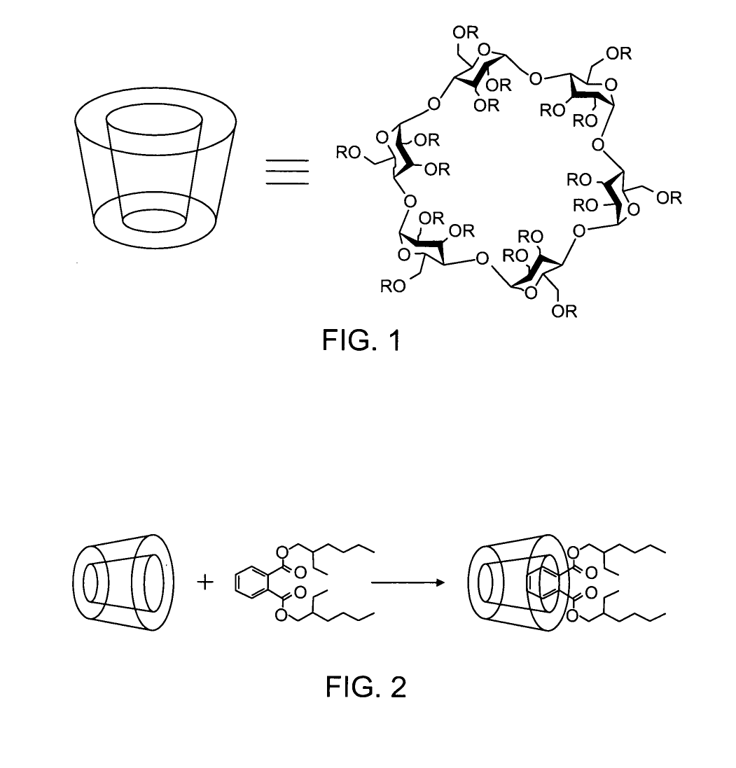

In the Chemistry Figure 3, R has a degree of substitution of 5 to 100%, preferably 20 to 90%, and the degree of substitution is calculated by the following Math Figure 1.

$$Substitution Degree = ( \frac{Total No . of Substituted Hydroxy Group}{\begin{matrix}Total No . of Hydroxy \\ Group in Cyclodextrin\end{matrix}} ) \times 100 ( \% ) \qquad [ Math Figure 1 ]$$

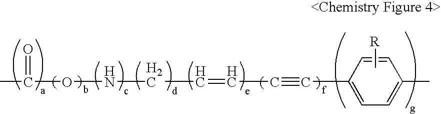

wherein a, b, c, d, e and f each is an integer of at least 0 and g is an integer of at least 1 with a+b+c+d+e+f+g being at least 1, and the linking order among the constituent units of a, b, c, d, e, f and g can vary at random. And, in the above Chemistry Figure 4, R is benzene, benzene derivatives, naphthalene, or naphthalene derivatives. R may be arranged regardless of the positions of ortho, meta and para.

A functional group represented by the above Chemistry Figure 4 may be any one selected from the group consisting of naphthyl, naphthoyl, anthracene and their derivatives, however the present invention is not limited in this regard.

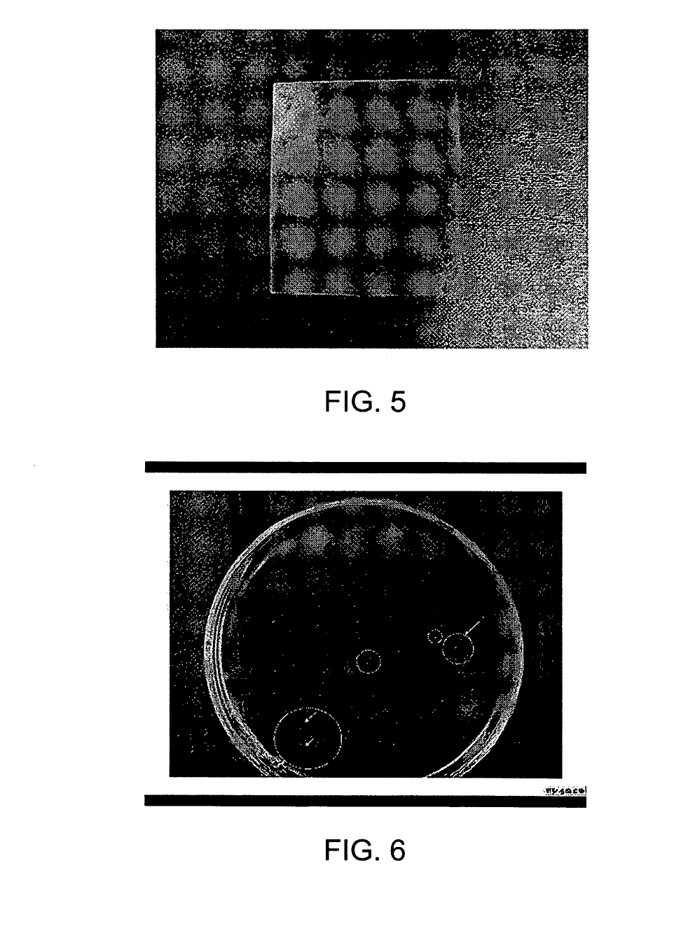

In the above Chemistry Figure 3, it is obvious that hydroxyl hydrogens may be substituted by another functional group in such a range represented by R of Chemistry FIG. 4 to the above-mentioned degree, and preferably the hydroxyl hydrogens are substituted by silane functional groups having 1 to 60 carbon atoms, represented by the following Chemistry Figure 8.

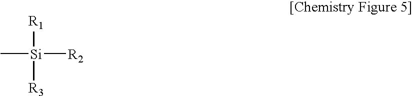

wherein R₁, R₂ and R₃ each is independently a functional group having 1 to 20 carbon atoms, represented by the Chemistry Figure 4. The silane functional group represented by the Chemistry Figure 5 may include trimethyl silane, butyldimethyl silane, methoxy silane, ethoxy silane or methacryloxypropyl trimethoxy silane, however the present invention is not limited in this regard.

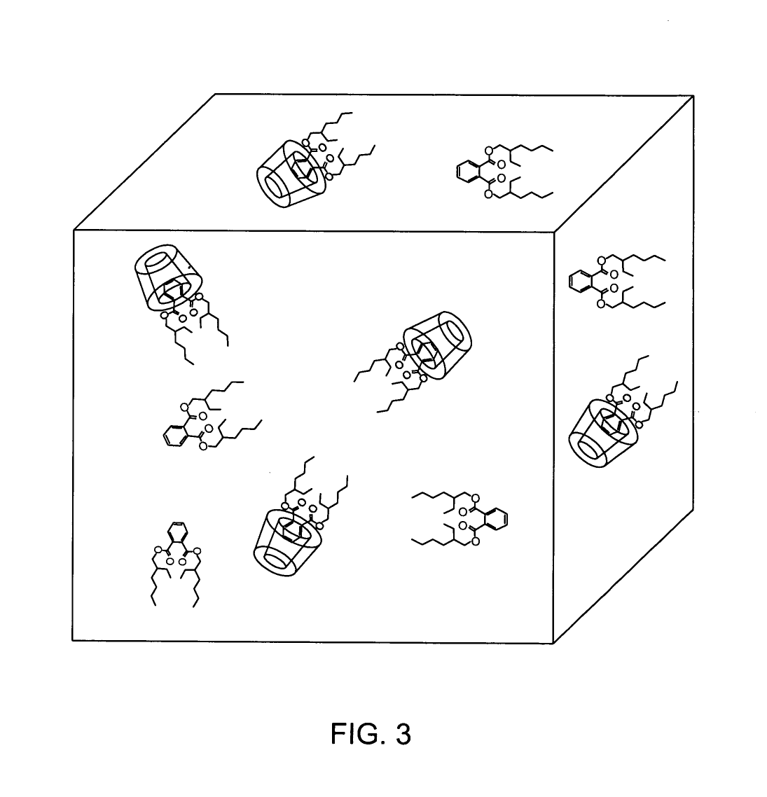

Such cyclodextrin derivatives may be manufactured by reacting the cyclodextrin represented by the Chemistry Figure 2 with a compound represented by the following Chemistry Figure 6.

R—X [Chemistry Figure 6]

wherein R is the same as R of the Chemistry Figure 3, and X is a functional group that can react with the hydroxyl functional group of the cyclodextrin represented by the Chemistry Figure 2, and for example, may include a halogen atom, a hydroxyl functional group or an alkoxy functional group. Through the substitution reaction, hydrogen atoms in the hydroxyl functional group of the cyclodextrin are substituted by R. In the substitution reaction, a degree in which the hydrogen atoms are substituted by R, i.e. the degree of substitution, may be controlled according to an input mole ratio of the compound represented by the Chemistry Figure 6.

Subsequently, the prepared cyclodextrin derivatives, PVC and a low molecular weight liquid plasticizer are mixed to form a plastisol (S2).

Unlike the pure cyclodextrin represented by Chemistry Figure 2, the cyclodextrin derivatives represented by Chemistry Figure 3, in which the hydrogen functional group is substituted by certain compounds, have good dispersibility when the cyclodextrin derivatives are mixed with PVC and the low molecular weight liquid plasticizer. Therefore, it is possible to form a plastisol having the cyclodextrin derivatives uniformly dispersed therein without a solution such as DMAc used in the prior art. As a result, a flexible PVC with suppression of plasticizer migration may be mass-produced in a simple and economical manner.

Preferably, the cyclodextrin derivatives have the content of 2 to 20 mol based on 100 mol content of the low molecular weight liquid plasticizer.

And, the low molecular weight liquid plasticizer may be any material capable of forming a complex through the inner cavity of the cyclodextrin derivatives. When the size of the inner cavity of the cyclodextrin derivatives is considered, the low molecular weight liquid plasticizer may be a typical low molecular weight liquid plasticizer used to make PVC flexible, for example any one or mixtures of at least one selected from the group consisting of phthalate plasticizers such as dimethyl phthalate (DMP), dibutyl phthalate (DBP), di-isobutyl phthalate (DIBP), dihexyl phthalate (DHP), dioctyl phthalate (DOP), diisooctyl phthalate (DIOP), dinonyl phthalate (DNP), di-isodecyl phthalate (DIDP) and benzyl butyl phthalate (BBP), an aliphatic diester plasticizer such as dioctyl adipate (DOA), diisooctyl adipate (DIOA) and diisodecyl adipate (DIDA), a trimellitate plasticizer such as triisooctyl trimellitate (TIOTM), and a phosphate plasticizers such as tri-tolyl phosphate (TTP) and trixylyl phosphate (TXP). A mixing ratio of PVC and the low molecular weight liquid plasticizer may be changed according to the desired ductility, which is apparent to an ordinary person in the art. For example, 10 to 80 parts by weight of the plasticizer is used based on 100 parts by weight of the PVC.

In step S2, the plastisol may be formed by simultaneously mixing the cyclodextrin derivatives, and PVC and the low molecular weight liquid plasticizer, or first mixing the cyclodextrin derivatives and the low molecular weight liquid plasticizer to form a plasticizer composition and then mixing the plasticizer composition with PVC. In other words, the plasticizer composition containing the cyclodextrin derivatives and the low molecular weight liquid plasticizer is first formed according to the present invention, and may be used instead of a typical plasticizer of PVC.

Finally, the plastisol is heated, and then cooled (S3).

The plastisol formed by adding the cyclodextrin derivatives represented by Chemistry Figure 3 to the flexible PVC composition containing PVC and the low molecular weight liquid plasticizer is heated, for example at about 180° C. and then cooled, so that a flexible PVC composition with suppression of plasticizer migration is manufactured, in which all of the components, i.e. PVC, the low molecular weight liquid plasticizer and the cyclodextrin derivatives are uniformly dispersed.

In the manufactured flexible PVC composition with suppression of plasticizer migration, a principle for suppressing plasticizer migration may be described as follows.

FIG. 1 is a view schematically illustrating the structure of alpha-cyclodextrin derivatives as an embodiment of cyclodextrin derivatives used in the present invention. Referring to FIG. 1, each alpha-cyclodextrin derivative has an inner cavity. Such cyclodextrin derivatives draw the low molecular weight liquid plasticizer, for example DOP into the inner cavity to form a complex, thereby preventing migration of the plasticizer (See FIG. 2). That is, as shown in FIG. 3, the flexible PVC composition of the present invention in which PVC, the low molecular weight liquid plasticizer and cyclodextrin derivative are uniformly dispersed, supports an efficient formation of a complex between the cyclodextrin derivatives and DOP. This improves the suppressing efficiency of plasticizer migration without deteriorating of the physical properties of the flexible PVC.

Hereinafter, preferred embodiments of the present invention will be described in detail with reference to the accompanying drawings. However, the description proposed herein is just a preferable example for the purpose of illustrations only, not intended to limit the scope of the invention, so it should be understood that other equivalents and modifications could be made thereto without departing from the spirit and scope of the invention. The preferred embodiments of the present invention will be described in detail for the purpose of better understandings, as apparent to a person having ordinary skill in the art.

### SYNTHETIC EXAMPLE 1

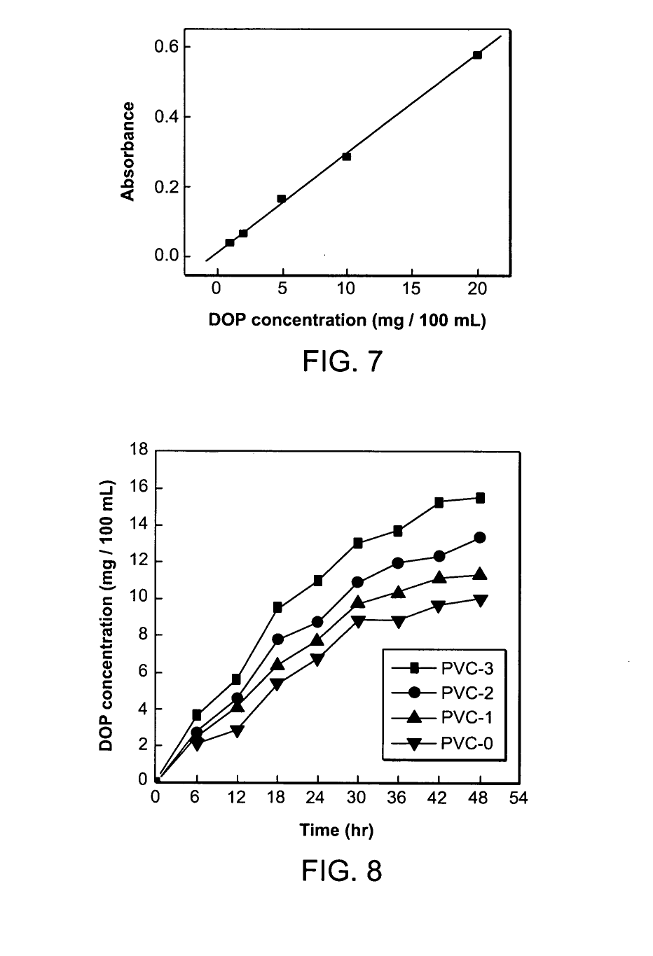

In this synthetic example 1, beta-cyclodextrin is reacted with naphthoyl chloride to synthesize cyclodextrin derivatives represented by the following Chemistry Figure 7.

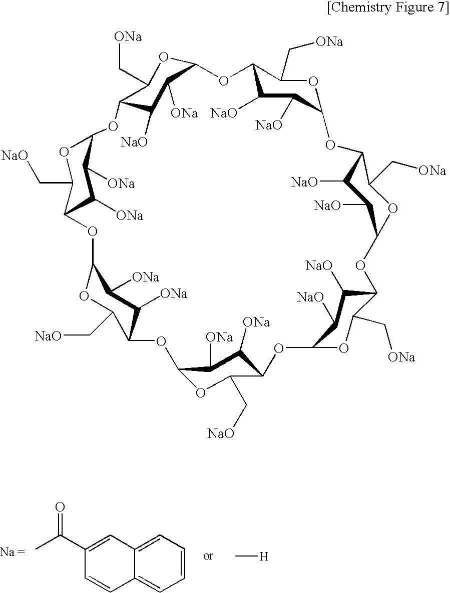

2,3,6-tri-O-naphthoyl-β-cyclodextrin (hereinafter, referred to as “Na-β-CD”) represented by Chemistry Figure 7 was synthesized according to a method disclosed in the Journal of American Chemical Society 1992, Vol. 114, P. 6427-6436 “Multichromophoric cylodextrins. 1. Synthesis of o-naphthoyl-β-cyclodextrins and investigation of excimer formation and energy hopping”.

The beta-cyclodextrin used in the reaction was purchased from Tokyo Kasei. 11.35 g (0.01 mol) of beta-cyclodextrin was dissolved in 150 ml of pyridine. Next, an excess of naphthoyl chloride was slowly dropped, agitated at 70° C. for about seven days, and separately extracted using ethyl acetate. The extracted organic layer was washed with 1 M of hydrochloric acid solution, and then dehydrated using Na₂SO₄ water. Then, the pyridine solution was removed under reduced pressure to obtain a precipitate.

The resultant Na-β-CD product was performed elementary analysis for carbon, hydrogen and oxygen atoms to calculate a weight ratio of each of the elements, and on the basis of the calculation, it was defined how much hydrogen of the terminal hydroxyl functional group of the beta-cyclodextrin was substituted, and according to the results, it was found that 19 hydroxyl functional groups corresponding to about 90.5% among a total of 21 hydroxyl functional groups of the beta-cyclodextrin were substituted in the reaction with naphthoyl chloride.

### Embodiment

This embodiment shows a manufacturing method of the flexible PVC composition with suppression of plasticizer migration using the cyclodextrin derivatives manufactured in synthetic example 1.

The PVC used was a commercial one (LG Chem. Ltd., LP170), and the plasticizer used was a typical low molecular weight liquid plasticizer, for example dioctyl phthalate (hereinafter referred to as DOP). The second plasticizer used, an epoxidized soybean oil was SDB CIZER-E03 made by Shin Dong Bang Corporation, and the heat stabilizer used was MT-800 made by Songwon Industrial Co., Ltd.

First, according to composition as represented in the following Table 1, PVC, DOP and the cyclodextrin derivatives obtained in the synthesis example 1 were put into a container along with other additives, a second plasticizer and a heat stability, and mechanically agitated for 24 hours to form a plastisol. The unit of the Table 1 is parts by weight.

TABLE 1

| | | | | Second | Heat | Cyclodextrin | |
|---|---|---|---|---|---|---|---|
| | Number | PVC | DOP | plasticizer | stabilizer | derivatives | Total |
| Comparison | PVC-0 | 100.00 | 57.00 | 3.00 | 2.00 | — | 162.00 |
| example 1 | | | | | | | |
| Embodiment 1 | PVC-1 | 100.00 | 57.00 | 3.00 | 2.00 | 1.63 | 163.63 |
| Embodiment 2 | PVC-2 | 100.00 | 57.00 | 3.00 | 2.00 | 5.01 | 167.01 |
| Embodiment 3 | PVC-3 | 100.00 | 57.00 | 3.00 | 2.00 | 10.34 | 172.34 |

The resultant plastisol was matured in a vacuum oven for about 2 weeks, and a predetermined amount of the plastisol was put into a frame and heated in a processing oven at 180° C. for about 5 to 10 minutes, and then was placed at a room temperature to manufacture flexible PVC samples with suppression of plasticizer migration.

The manufactured samples were numbered according to the wt % of the content of cyclodextrin derivatives based on a total content of plastisol. For example, plastisols with cyclodextrin derivative contents of 0, 2.5, 3.7 and 5.8 wt % were designated as PVC-0, PVC-1, PVC-2 and PVC-3, respectively.

Evaluation of Dispersion of Cyclodextrin Derivatives

FIG. 4 is a surface photograph of the sample (PVC-0) of comparison example 1 containing no cyclodextrin derivatives, and FIG. 5 is a surface photograph of the sample (PVC-3) of comparison example 3 containing a predetermined amount of cyclodextrin derivatives. And, FIG. 6 is a surface photograph of a sample manufactured by dispersing a pure beta-cyclodextrin in DMAc solution according to the prior art.

As shown in FIG. 6, the PVC compositions produced according to the present invention were monitored for the occurrence of aggregation, a known limitation in the manufacturing of flexible PVCs with suppressed plasticizer migration by means of pure beta-cyclodextrin. As shown in the photograph, there was little difference in surface morphology between PVC-3 and PVC-0, which means cyclodextrin derivatives are not cohered to each other, but uniformly dispersed in the flexible PVC.

Evaluation of Plasticizer Migration

The manufactured flexible PVC samples were tested for plasticizer migration through the below-mentioned process. The migration test was carried out in conformity with conditions based on a method of ISO (International Standard Organization) 3826 “Plastics collapsible containers for human blood and blood components”.

First, to determine the DOP concentration, various concentrations of DOP standard solutions were prepared through the below-mentioned steps, and a calibration curve was plotted by measuring the absorbance of the DOP standard DOP solutions at the wavelength of 272 nm using a UV-vis. spectrophotometer.

The DOP standard solution was manufactured to have DOP content of 1, 2, 5, 10 or 20 mg in a 100 ml solution of ethyl alcohol/water used in the DOP migration test, and its manufacturing method is described in detail, as follows.

The DOP migration solution was prepared by suitably mixing ethyl alcohol and water so that a density of the ethyl alcohol/water mixed solution was 0.9373 to 0.9378 g/ml. At this time, the used ethyl alcohol had a purity of 95.1 to 96.6 % (v/v) and a density of 0.8050 to 0.8123 g/ml. lg of DOP was added to the ethyl alcohol so that the mixed solution had a volume of 100 ml. 10 ml of the mixed solution was diluted with the migration solution so that the diluted solution had a volume of 100 ml. 1, 2, 5, 10 and 20 ml of the diluted solutions were re-diluted with the migration solution so that the re-diluted solutions each had a volume of 100 ml. Through this process, 100 ml of the standard solutions were manufactured with 1, 2, 5, 10 and 20 mg of DOP concentrations.

The absorbance of the standard DOP solutions at the wavelength of 272 nm was measured using the UV-vis. spectrophotometer, and a calibration curve was plotted based on the measurement. The calibration curve was conformable to Beer-Lambert equation, and the DOP concentration was calculated through the absorbance of the sample materials. The Beer-Lambert equation was represented by the following Math Figure 2.

$$\begin{matrix}Absorbance = ( Intensity of light going into the sample / \\ Intensity of light \\ emitting from the sample ) \\ = Molecular absorbance coefficient \times \\ Concentration \times Light penetration length\end{matrix} \qquad [ Math Figure 2 ]$$

The manufactured flexible PVC samples were put into 100 g of the migration solution and sealed tightly, and maintained at an ambient temperature of 37±1° C. And, the absorbance of the migration solutions was measured at the wavelength of 272 nm using the UV-vis. spectrophotometer at regular time intervals, the measured absorbance was applied to the calibration curve to calculate the concentration of DOP migrated from the samples, and the result is shown in the following Table 2 and FIG. 8. The unit of the Table 2 is mg/100 ml.

TABLE 2

| | After 6 | After 12 | After 24 | After 36 | After 48 |
|---|---|---|---|---|---|
| Number | hours | hours | hours | hours | hours |
| PVC-0 | 3.567 | 5.595 | 10.970 | 13.716 | 15.519 |
| PVC-1 | 2.736 | 4.597 | 8.725 | 11.934 | 13.321 |
| PVC-2 | 2.503 | 4.093 | 7.733 | 10.375 | 11.320 |
| PVC-3 | 2.076 | 3.167 | 6.776 | 8.846 | 10.046 |

Referring to Table 2 and FIG. 8, as the content of cyclodextrin derivatives increases, that is, movement from PVC-0 to PVC-3, the DOP concentration reduces. This proves that the cyclodextrin derivatives suppress migration of the plasticizer, i.e. DOP. In particular, even a small amount of cyclodextrin derivatives is considerably effective in suppressing migration of the plasticizer. Such effectiveness in suppression is presumed to be attributable to the cyclodextrin derivatives forming hydrogen bonds to draw and fix the low molecular weight liquid plasticizer to their peripheries in addition to drawing the plasticizer into their inner cavities.

Evaluation of Physical Properties of Flexible PVC

This evaluation investigates the influence that the cyclodextrin derivatives contained in the flexible PVC have on a mechanical property of the flexible PVC.

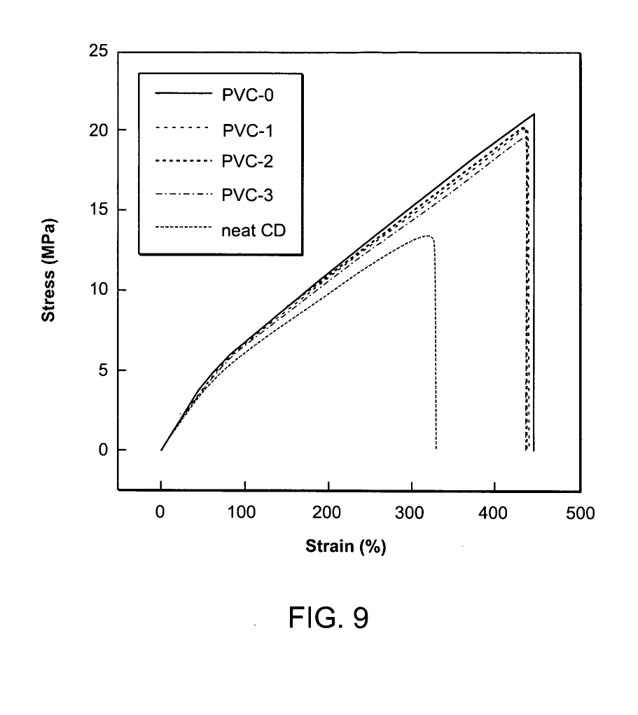

First, the samples were shaped into dumbbell specimens using a sample manufacturing machine for a tensile strength test. These samples were strained at a crosshead speed of 50 mm/min using a universal testing machine (UTM) named LR10K from Lloyd Instruments Ltd, and the load was measured. The obtained stress-strain curve is shown in FIG. 9.

Referring to FIG. 9, as the concentration of Na-β-CD, a cyclodextrin derivative increases, the stress-strain at the breaking point reduces within narrow limits. However, the overall change of strain-stress is insignificant as it varies less than 10%. Therefore, it is found that the flexible PVCs containing cyclodextrin derivatives have little deterioration of their mechanical properties.

### APPLICABILITY TO THE INDUSTRY

As described above, the manufacturing method of flexible PVC with suppression of plasticizer migration according to the present invention uses cyclodextrin derivatives. These derivatives are cyclodextrins substituted by certain compounds that form a complex with the low molecular weight liquid plasticizer. The use of such cyclodextrin derivatives allows mass-producing the flexible PVC with suppression of plasticizer migration in simple and economical manner without using a solvent.

And, the manufactured flexible PVC has the low molecular weight liquid plasticizer and the cyclodextrin derivatives uniformly dispersed therein, and the cyclodextrin derivatives form a complex with the low molecular weight liquid plasticizer, thereby improving a suppressing efficiency of plasticizer migration without deterioration of its mechanical property.

What is claimed is:

1. A manufacturing method of flexible poly(vinyl chloride) (PVC) composition with suppression of the migration of plasticizer, the method comprising the steps of:
(S1) preparing a cyclodextrin derivative represented by the following Chemistry Figure 3;
(S2) mixing the cyclodextrin derivative, PVC and a low molecular weight liquid plasticizer to form a plastisol; and
(S3) heating the plastisol into liquid and cooling the plastisol: 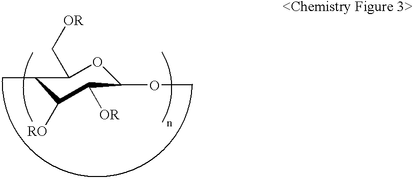
wherein each R, having 1 to 20 carbon atoms, is a functional group independent of one another, represented by the following Chemistry Figure 4 and has a degree of substitution of 5 to 100%, and n is an integer of 6 to 26, and 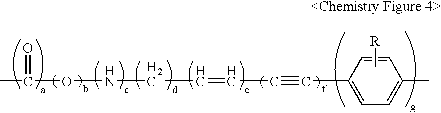
wherein a, b, c, d, e and f each respectively is an integer of at least 0 and g is an integer of at least 1 with a+b+c+d+e+f+g being at least 1, and wherein the linking order among said constituent units of a, b, c, d, e, f and g can vary at random, and R is benzene, benzene derivatives, naphthalene, or naphthalene derivatives.

2. The manufacturing method of flexible PVC composition with suppression of the migration of plasticizer according to claim 1,
wherein the content for said cyclodextrin derivative is in the range of 2 to 20 moles based on 100 moles of the low molecular weight liquid plasticizer.

3. The manufacturing method of flexible PVC composition with suppression of the migration of plasticizer according to claim 1,
wherein the low molecular weight liquid plasticizer is any one selected from the group consisting of phthalate plasticizers, aliphatic diester plasticizers, trimellitate plasticizers and phosphate plasticizers.

4. The manufacturing method of flexible PVC composition with suppression of the migration of plasticizer according to claim 3,
wherein the phthalate plasticizer is any one selected from the group consisting of dimethyl phthalate (DMP), dibutyl phthalate (DBP), di-isobutyl phthalate (DIBP), dihexyl phthalate (DHP), dioctyl phthalate (DOP), di-isooctyl phthalate (DIOP), dinonyl phthalate (DNP), di-isodecyl phthalate (DIDP), benzyl butyl phthalate (BBP) and mixtures thereof.

5. The manufacturing method of flexible PVC composition with suppression of the migration of plasticizer according to claim 1,
wherein the functional group represented by the above Chemistry Figure 4 is any one selected from the group consisting of naphthyl, naphthoyl, anthracene and their derivatives.

6. A flexible poly(vinyl chloride) (PVC) composition with suppression of the migration of plasticizer, comprising PVC and a low molecular weight liquid plasticizer, the flexible PVC composition further comprising:
a cyclodextrin derivative represented by the following Chemistry Figure 3: 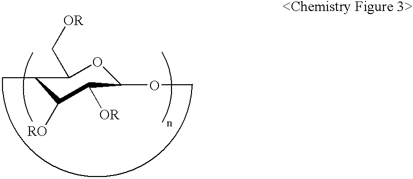
wherein each R, having 1 to 20 carbon atoms, is a functional group independent of one another, represented by the following Chemistry Figure 4 and has a degree of substitution of 5 to 100%, and n is an integer of 6 to 26, and 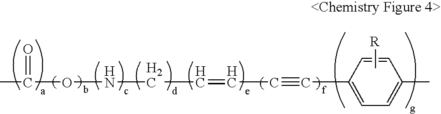
wherein a, b, c, d, e and f each respectively is an integer of at least 0 and g is an integer of at least 1 with a+b+c+d+e+f+g being at least 1, and wherein the linking order among said constituent units of a, b, c, d, e, f and g can vary at random, and R is benzene, benzene derivatives, naphthalene, or naphthalene derivatives.

7. The flexible PVC composition with suppression of the migration of plasticizer according to claim 6,
wherein the content for said cyclodextrin derivative is in the range of 2 to 20 moles based on 100 moles of the low molecular weight liquid plasticizer.

8. The flexible PVC composition with suppression of the migration of plasticizer according to claim 6,
wherein the low molecular weight liquid plasticizer is any one selected from the group consisting of phthalate plasticizers, aliphatic diester plasticizers, trimellitate plasticizers and phosphate plasticizers.

9. The flexible PVC composition with suppression of the migration of plasticizer according to claim 8,
wherein the phthalate plasticizer is any one selected from the group consisting of dimethyl phthalate (DMP), dibutyl phthalate (DBP), di-isobutyl phthalate (DIBP), dihexyl phthalate (DHP), dioctyl phthalate (DOP), diisooctyl phthalate (DIOP), dinonyl phthalate (DNP), diisodecyl phthalate (DIDP), benzyl butyl phthalate (BBP) and mixtures thereof.

10. The flexible PVC composition with suppression of the migration of plasticizer according to claim 6,
wherein the functional group represented by the above Chemistry Figure 4 is any one selected from the group consisting of naphthyl, naphthoyl, anthracene and their derivatives.

11. A plasticizer composition, comprising:
a low molecular weight liquid plasticizer; and
a cyclodextrin derivative represented by the following Chemistry Figure 3: 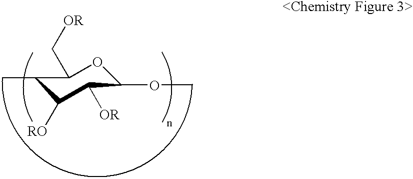
wherein each R, having 1 to 20 carbon atoms, is a functional group independent of one another, represented by the following Chemistry Figure 4 and has a degree of substitution of 5 to 100%, and n is an integer of 6 to 26, and 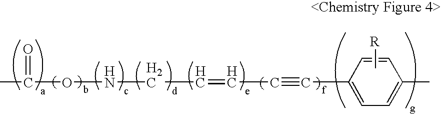
wherein a, b, c, d, e and f each respectively is an integer of at least 0 and g is an integer of at least 1 with a+b+c+d+e+f+g being at least 1, and wherein the linking order among said constituent units of a, b, c, d, e, f and g can vary at random, and R is benzene, benzene derivatives, naphthalene, or naphthalene derivatives.

12. The plasticizer composition according to claim 11,
wherein the content for said cyclodextrin derivative is in the range of 2 to 20 moles based on 100 moles of the low molecular weight liquid plasticizer.
